(19) United States
(12) Patent Application Publication
(10) Pub. No.: US 2026/0091382 A1
(43) Pub. Date: Apr. 2, 2026

(54) ADJUSTABLE GRIP SUPPORT FOR HANDHELD PIPETTE

(71) Applicant: Fate Therapeutics, Inc., San Diego, CA (US)

(72) Inventor: Craig Lawyer, San Diego, CA (US)

(21) Appl. No.: 19/341,746

(22) Filed: Sep. 26, 2025

Related U.S. Application Data
(60) Provisional application No. 63/700,587, filed on Sep. 27, 2024.

(51) Int. Cl. B01L 3/02

(52) U.S. Cl. CPC B01L 3/0286

(57) ABSTRACT

Grip support devices for use with a manually operated handheld pipette, e.g., a micropipette, to reduce strain on the user's hand during operation of the pipette are provided. The grip support devices include an adjustable strap for supporting the pipette on the user's hand, and which may be adjusted to accommodate various user hand sizes. In some embodiments, the strap may be removably coupled to the grip support device in various configurations to accommodate both a right-handed user and a left-handed user. In addition, the grip support device may include an extended portion to provide additional support to the thenar region of the user's hand, e.g., during gripping of the pipette.

### CROSS-REFERENCE TO RELATED APPLICATION

This application claims the benefit of U.S. Provisional Patent Application Ser. No. 63/700,587, filed Sep. 27, 2024, the entire contents of which are incorporated herein by reference.

### TECHNICAL FIELD

This technology generally relates to grip support devices for supporting manual operation of a handheld pipette while reducing strain on the user's hand during operation of the pipette.

### BACKGROUND

Pipettes, e.g., micropipettes, are a fundamental tool used in multiple disciplines for transferring a precise amount of liquid from one container to another. However, pipetting activities have been identified as a cause of injuries to the user's hand, arm, and shoulder. Specifically, manual pipetting can cause musculoskeletal disorders such as repetitive strain injury (RSI), which may cause pain, aching, stiffness, throbbing, tingling, numbness, weakness, and cramps, as well as other injuries such as tendonitis, trigger finger, Carpal Tunnel Syndrome, and/or Cubital Tunnel Syndrome which may cause pain in the thumb, forearm, elbow, neck, or shoulder.

For example, repetitive motion of the thumb, wrist, and hand, as well as the force required to operate the plunger and eject the tip may cause RSI. Additionally, sitting or standing in a static position for long periods can also contribute to RSI. While the recovery time from RSI varies from person to person, if left untreated, RSI can become difficult to treat and may result in long-term disability. Moreover, gripping the pipette tightly and performing repetitive and forceful plunger and tip ejection activities with the thumb may cause inflammation of the sheath that surrounds a tendon, e.g., Tenosynovitis (paratenonitis), also known as DeQuervain's, trigger finger, or Pipettor's Thumb. Flexing, extending, and rotating the wrist while pipetting, inserting, and ejecting may cause compression of the median nerve and vessels running through the carpal tunnel in the wrist due to a swollen tendon or tendon sheath, e.g., Carpal Tunnel Syndrome. Symptoms of Carpal Tunnel Syndrome include pain, numbness, tingling sensations, and weakness in the palm and in the thumb, index, and middle fingers, as well as sharp pains radiating through the neck in advanced cases. In addition, tip insertion and using wrist movements to manipulate the pipette may cause inflammation of the tendon, e.g., Tendinitis, and resting the elbow on a hard lab bench while pipetting may cause compression of the ulnar nerve in the cubital tunnel in the elbow, e.g., Cubital Tunnel Syndrome.

### SUMMARY

In view of the foregoing drawbacks, there exists a need for a device that improves efficiency, alleviates physical stress and strain, and reduces risk of injury during manual operation of a handheld pipette.

Provided herein are grip support devices for supporting manual operation of a pipette. For example, the device may include a main body comprising an upper portion defining an inlet, a lower portion defining an outlet, and a lumen extending between the inlet and the outlet, the lumen sized and shaped to receive at least a portion of the pipette therethrough such that a distal portion of the pipette extends distally beyond the outlet and a proximal portion of the pipette extends proximally from the inlet, and a strap configured to extend between the upper and lower portions of the main body to define an opening sized and shaped to receive a user's fingers therethrough. The strap may be configured to be selectively adjusted to modify the size of the opening. Accordingly, when the at least the portion of the pipette is received within the lumen and the user's fingers are received through the opening, the strap supports the pipette on the user's hand to permit actuation of the pipette.

A first end of the strap may be coupled to the lower portion or the upper portion, and a second end of the strap may be configured to be adjustably coupled to the other one of the lower portion or the upper portion. For example, the other one of the lower portion or the upper portion may comprise a first mating surface, and the second end of the strap may comprise a second mating surface configured to be removably coupled to the first mating surface. In some embodiments, the first mating surface may comprise a peg, and the second mating surface may comprise a plurality of notches, each of the plurality of notches sized and shaped to securely receive the peg therethrough via an interference fit. The device further may include a buckle disposed adjacent to the first mating surface, the buckle defining an opening sized and shaped to receive the second end of the strap therethrough to facilitate securement of the second mating surface to the first mating surface. Additionally, or alternatively, the first and second mating surfaces may comprise reclosable fasteners.

In some embodiments, the first end of the strap may be coupled to a central region of a lower surface of the lower portion or to a central region of an upper surface of the upper portion. For example, the first mating surface may be disposed on a central region of a lower surface of the lower portion or on a central region of an upper surface of the upper portion, and the second mating surface may be configured to be removably coupled to the first mating surface at a first orientation to accommodate a right-handed user and removably coupled to the first mating surface at a second orientation to accommodate a left-handed user. Alternatively, both right and left lateral sides of the other one of the lower portion or the upper portion may comprise the first mating surface, such that the second mating surface may be configured to be removably coupled to the first mating surface on the right lateral side to accommodate a right-handed user and removably coupled to the first mating surface on the left lateral side to accommodate a left-handed user. The first end of the strap may be fixedly coupled to the lower portion or the upper portion.

A middle region of the strap may comprise a width that is larger than a width of the first and/or second ends of the strap. In addition, the main body may comprise a deformable material. Further, the main body may comprise a smooth outer surface configured to facilitate disinfection. A rear portion of the main body may comprise an extended portion sized and shaped to facilitate gripping of the pipette and the main body by the user when the at least the portion of the pipette is received within the lumen and the user's fingers are received through the opening. For example, the extended portion may increase a gripped dimension of the pipette by at least 10%. Moreover, an upper portion of the extended portion may comprise a curved surface configured to support a thenar region of the user's hand. In some embodiments, the extended portion may be removably coupled to the rear portion of the main body. For example, the extended portion may be selected from a plurality of interchangeable extended portions, each of the interchangeable extended portions sized and shaped to accommodate a predetermined user hand size.

In accordance with one aspect, an outer surface of the main body may extend continuously between the upper and lower portions of the main body. Accordingly, the main body may comprise a window extending from the lumen to an outer surface of the main body, the window configured to be aligned with an indicator of the pipette when the at least the portion of the pipette is received within the lumen. Alternatively, the upper portion may only be coupled to the lower portion via the strap. For example, the upper portion may comprise an upper loop configured to be removeably coupled to the proximal portion of the pipette, and the lower portion may comprise a lower loop configured to be removably coupled to the distal portion of the pipette. Moreover, the inlet may be sized and shaped to expose one or more actuators on the proximal portion of the pipette in an unobstructed manner when the at least the portion of the pipette is received within the lumen. Additionally, when the at least the portion of the pipette is received within the lumen and the user's fingers are received through the opening, the strap may extend along or adjacent the user's knuckle to support the pipette on the user's hand. In addition, a pipette comprising the device may be provided, wherein the device and the pipette are separable. In accordance with one aspect, a method of reducing risks of repetitive strain injury associated with manually operating a pipette is provided. For example, the method may comprise attaching the device to the pipette.

In accordance with another aspect, a device for supporting manual operation of a pipette having a top end, a middle portion, and a bottom end, the top end being wider than and proximal to the middle portion, and the middle portion being wider than and proximal to the bottom end, is provided. The device may comprise an upper loop sized and shaped to receive the bottom end and the middle portion of the pipette therethrough, and to be retained at the top end of the pipette, a lower loop sized and shaped to receive the bottom end of the pipette therethrough, and to be retained by the middle portion of the pipette, and a strap connecting the upper loop and the lower loop. The strap, when attached to the pipette via the upper and lower loops, may define an opening sized and shaped to (i) receive a user's fingers therethrough, (ii) support the pipette on the user's hand, and (iii) permit actuation of the pipette when held. Moreover, a pipette comprising the device may be provided, wherein the device and the pipette are separable, and wherein the strap forms the opening.

### BRIEF DESCRIPTION OF THE DRAWINGS

FIG. 1A illustrates an exemplary grip support for use with a pipette in accordance with some embodiments.

FIG. 1B illustrates the grip support of FIG. 1A coupled to a pipette.

FIG. 2 illustrates a conventional pipette.

FIG. 3A illustrates an alternative exemplary grip support for use with a pipette in accordance with some embodiments.

FIG. 3B is a top view of the grip support of FIG. 3A, and FIG. 3C is a bottom view of the grip support of FIG. 3A.

FIGS. 3D and 3E illustrate the grip support of FIG. 3A in an open configuration.

FIGS. 4A to 4D illustrate the grip support of FIG. 3A coupled to a pipette.

FIGS. 5A to 5C illustrate operation of a pipette coupled to the grip support of FIG. 3A.

FIGS. 6A and 6B illustrate an exemplary universal grip support for use with a pipette in accordance with some embodiments.

FIGS. 6C and 6D illustrate the universal grip support of FIGS. 6A and 6B coupled to a pipette.

FIGS. 7A and 7B illustrate an alternative exemplary universal grip support for use with a pipette in accordance with some embodiments.

FIG. 8 illustrates an alternative exemplary grip support for use with a pipette having interchangeable extended portions in accordance with some embodiments.

### DETAILED DESCRIPTION

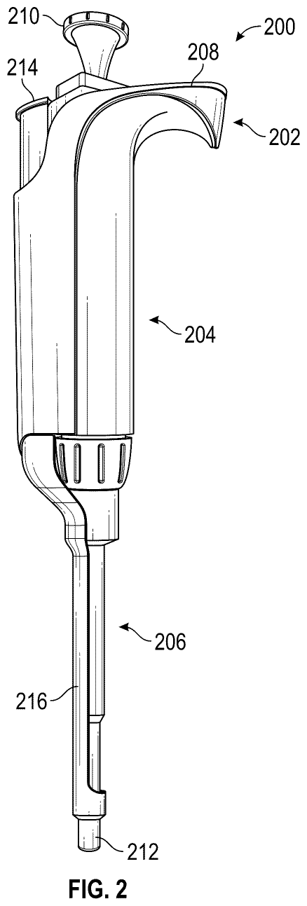

Embodiments of this technology are directed to exemplary grip support devices for use with a manually operated handheld single-or multi-channeled pipette for transferring precise amounts of liquid, while reducing strain on the user's hand, arm, and shoulder, to thereby reduce the risk of repetitive strain injury (RSI) and damages to muscles, tendons or nerves associated with repetitive operation of a pipette. The grip support devices described herein are suitable for use with conventional off-the-shelf pipettes used in laboratory settings, e.g., an adjustable-volume micropipette, as shown in FIG. 2, and includes a strap for supporting the pipette on the user's hand. The strap may be adjustable to accommodate various user hand sizes. In some embodiments, the strap may be removably coupled to the grip support in various configurations to accommodate both a right-handed user and a left-handed user. Preferably, the grip support does not obstruct any of the pipette's actuators or fingerhook, if any, such that the user may operate the pipette in the same manner as when there is no grip support coupled thereto, albeit with reduced strain on the user's fingers, wrist and forearm during operation of the pipette. In some embodiments, the grip support may include an extended portion to provide additional support to the thenar region of the user's hand, e.g., during gripping of the pipette.

For example, as exemplified in FIG. 2, the micropipette (referred to as “pipette 200” herein) may be a manual handheld micropipette including, but not limited to, a Rainin™ pipette (made available by Mettler-Toledo, LLC, Columbus, Ohio), configured for transferring precise amounts of liquid from one container to another. Pipette 200 includes top end 202, middle portion 204 distal to top end 202, and bottom end 206 distal to middle portion 204. As shown in FIG. 2, middle portion 204 may be wider, e.g., have a larger cross-sectional area, than bottom end 206, and top end 202 may be wider than middle portion 204. Top end 202 may include one or more actuators for controlling operation of pipette 200. For example, top end 202 may include plunger 210 configured to be actuated to draw liquid into pipette 200 via tip 212 at the distal end of bottom end 206, as well as to dispense liquid from pipette 200 via tip 212, and tip ejector button 214 operatively coupled to tip ejector 216 and configured to be actuated to cause tip ejector 216 to eject a disposable pipette tip (not shown) coupled to tip 212 of pipette 200.

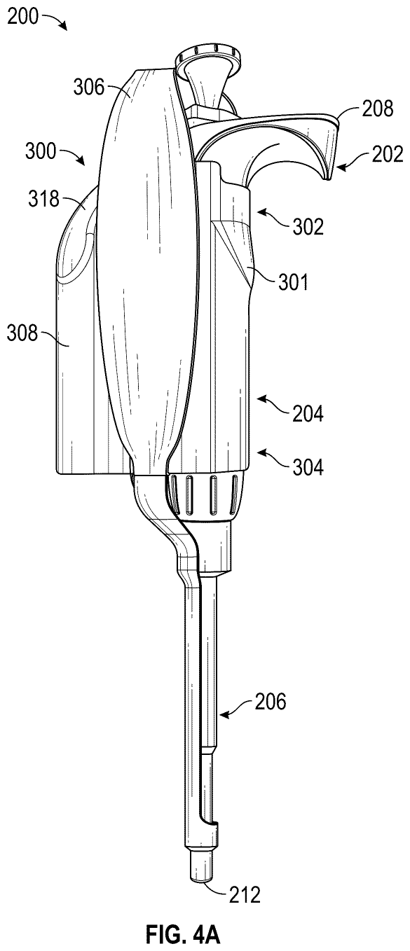

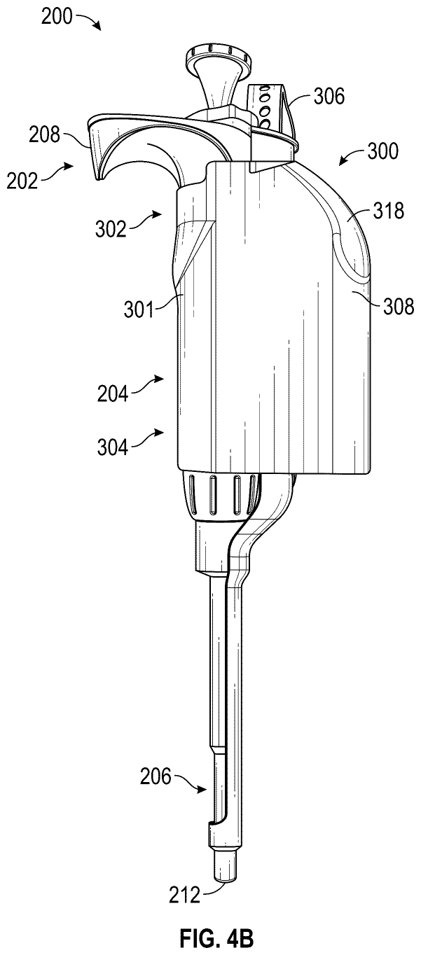

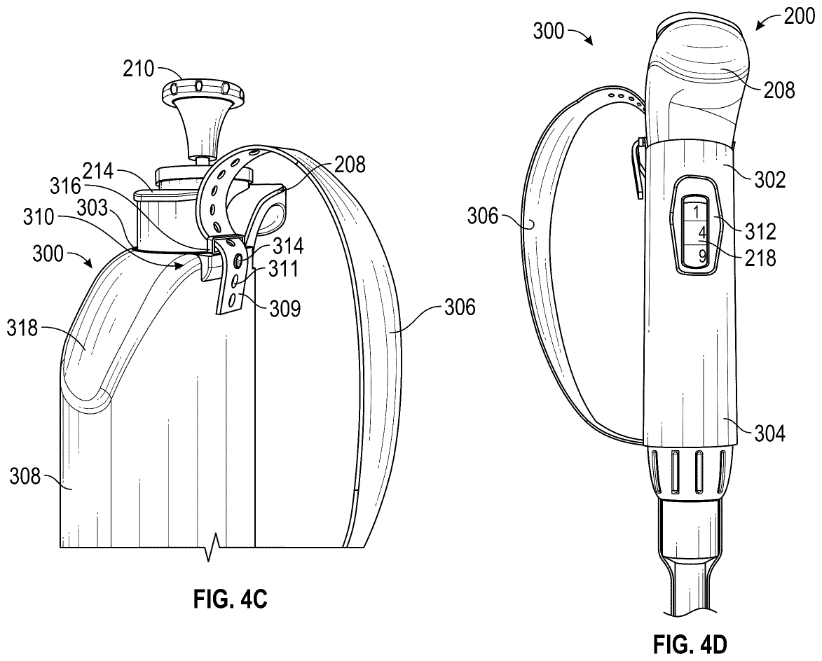

As shown in FIG. 2, pipette 200 further may include fingerhook 208 extending radially away from a longitudinal axis of pipette, e.g., in a direction away from the user's hand when the user grips pipette 200. The lower surface of fingerhook 208 may have a curved geometry configured to support fingerhook 208, and accordingly pipette 200, on the user's finger, e.g., the user's index finger, during operation of pipette 200. In addition, the amount of liquid within pipette 200 may be measured, e.g., via a piston-cylinder system in the handle of pipette 200, and displayed via an indicator (e.g., indicator 218, as shown in FIG. 4D) disposed on a lateral side of pipette 200. The indicator may be mechanical, electrical, or both. During operation of pipette 200, a user grips middle portion 204 such that the user's fingers wrap around middle portion 204 underneath fingerhook 208, and the user's thumb actuates plunger 210 and/or tip ejector button 214 while exerting force to effectuate the grip with other fingers wrapped around middle portion 204. The indicator may be disposed on the lateral front side of middle portion 204 below fingerhook 208, such that the user may readily view the indicator during operation of pipette 200, e.g., by unwrapping one or more fingers from middle portion 204. While FIG. 2 illustrates a single-channel air displacement pipette, as will be understood by a person having ordinary skill in the art, the grip support devices described herein may be used with other off-the-shelf handheld pipettes, such as multichannel and/or multichannel adjustable spacer pipettes.

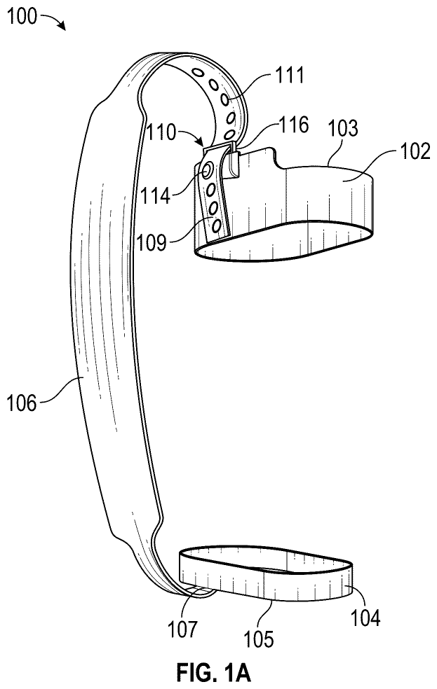

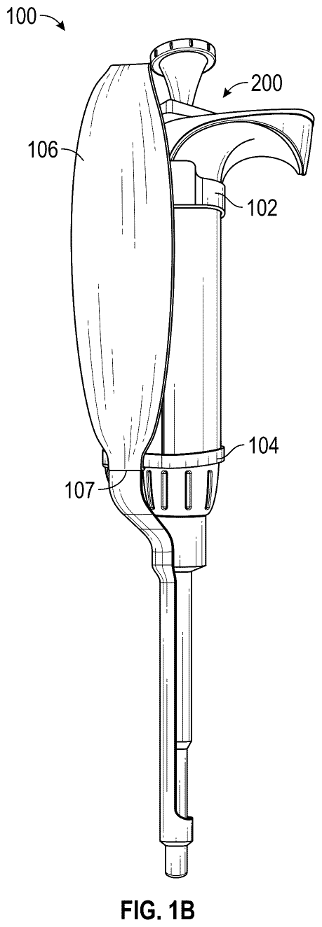

Referring now to FIGS. 1A and 1B, an exemplary grip support for use with a manually operated handheld pipette, e.g., pipette 200, is provided. As shown in FIG. 1A, the main body of grip support 100 may include an upper portion, e.g., upper loop 102, a lower portion, e.g., lower loop 104, and strap 106 connecting upper loop 102 and lower loop 104. Upper loop 102 may have a loop-shaped structure defining inlet 103 and lower loop 104 may have a loop-shaped structure defining outlet 105, such that the bottom end of the pipette may be inserted through inlet 103 of upper loop 102 and through lower loop 104 such that the bottom end of the pipette extends distally beyond outlet 105. Accordingly, grip support 100 has a lumen extending between inlet 103 and outlet 105, e.g., through upper loop 102 and through lower loop 104, and sized and shaped to receive respective portions of the pipette therethrough. For example, the lumen of upper loop 102 may be sized and shaped to receive bottom end 206 and middle portion 204 of pipette 200, therethrough, such that upper loop 102 may be retained at top end 202 of pipette 200, and lower loop 104 may be sized and shaped to receive bottom end 206 of pipette 200, therethrough, such that lower loop 104 may be retained by middle portion 204 of pipette 200, as shown in FIG. 1B. Moreover, upper loop 102 may be sized and shaped such that, when upper loop 102 is retained at top end 202 of pipette 200, all of the actuators of pipette 200, plunger 210 and tip ejector button 214, and fingerhook 208 are exposed from inlet 103 and unobstructed by grip support 100, such that the user may operate pipette 200 in the same manner as when grip support 100 is not coupled to pipette 200, albeit with reduced strain on the user's thumb, wrist and forearm during operation of pipette 200.

Upper loop 102 and lower loop 104 may be formed of a deformable material to facilitate insertion of the pipette through inlet 103 and outlet 105, as well as coupling and removal of upper loop 102 and lower loop 104 from the pipette. In some embodiments, the size of the lumen defined by upper loop 102 and/or lower loop 104 may be selectively adjustable, e.g., by adjusting their respective lengths, to thereby accommodate various pipette sizes. Preferably, the external surfaces of upper loop 102 and lower loop 104 are smooth to thereby facilitate disinfection and cleaning of grip support 100. Strap 106 may be formed of the same deformable material as upper loop 102 and lower loop 104, and also may have smooth external surfaces to facilitate disinfection and cleaning thereof. When grip support 100 is removably coupled to pipette 200, strap 106 defines an opening between strap 106 and middle portion 204, the opening sized and shaped to receive the user's fingers therethrough, and sits on the backside of the user's hand. Strap 106 may be fixedly coupled to a first portion of grip support 100 at a first end, and adjustably coupled to a second portion of grip support 100 at a second end opposite the first end, such that the size of the opening defined by strap 106 may be selectively adjusted to thereby accommodate various user hand sizes. For example, as shown in FIG. 1A, first end 107 of strap 106 may be fixedly coupled to lower loop 104 and free end 109 of strap 106 may be adjustably coupled to upper loop 102 via connection mechanism 110.

Connection mechanism 110 may include a first mating surface disposed on upper loop 102 and a second mating surface disposed on free end 109 of strap 106, the first and second mating surfaces configured to be removeably coupled to each other. For example, as shown in FIG. 1A, the first mating surface of connection mechanism 110 may include one or more pegs, e.g., peg 114, disposed on upper loop 102, and the second mating surface of connection mechanism 110 may include a plurality of notches 111 disposed along free end 109 of strap 106, each notch sized and shaped to removably and securely receive peg 114 therethrough, e.g., via an interference fit. Notches 111 may be disposed laterally along a length of free end 109, such that the user may selectively engage peg 114 with any one of notches 111 to thereby select the length of strap 106 defining the opening, and thus customize the size of the opening to accommodate a given user hand size.

Moreover, connection mechanism 110 further may include buckle 116 disposed adjacent to peg 114, and defining an opening sized and shaped to receive free end 109 therethrough, e.g., prior to coupling peg 114 to notch 111, to thereby facilitate securement of free end 109 to upper loop 102. For example, free end 109 may be inserted through buckle 116, e.g., from a radially inward side of buckle 116 towards a radially outward side of buckle 116, in a downward direction towards peg 114. Accordingly, free end 109 may be completely separated from upper loop 102 in an open configuration, and adjustably coupled to upper loop 102 via connection mechanism 110 in a closed configuration. Alternatively, free end 109 may remain engaged with, though adjustable relative to, upper loop 102, e.g., via a stop that prevents free end 109 from being completely removed through buckle 116.

While FIG. 1A illustrates first end 107 fixedly coupled to lower loop 104 and free end 109 adjustably coupled to upper loop 102, as will be understood by a person having ordinary skill in the art, first end 107 may be fixedly coupled to upper loop 102 and free end 109 may be adjustably coupled to lower loop 104, such that connection mechanism 110 is disposed at lower loop 104. Alternatively, strap 106 may be adjustably coupled to both upper loop 102 and lower loop 104 of grip support 100, e.g., via respective connection mechanisms. Moreover, instead of an adjustable peg/notch fastener system, connection mechanism 110 may include other types of adjustable fastener systems including, for example, reclosable fasteners, e.g., hook and loop fasteners, snaps, magnets, clips etc. For example, the first mating surface of connection mechanism 110 may include a plurality of hook and/or loop fasteners, and the second mating surface of connection mechanism 110 may include a plurality of loop and/or hook fasteners configured to releasably engage with the first mating surface.

In addition, grip support 100 may be universal, in the sense that it may be removably coupled to pipette 200 in a first orientation, as shown in FIG. 1B, such that strap 106 forms the opening on the right side of pipette 200 to thereby accommodate a right-handed user, or alternatively, grip support 100 may be removably coupled to pipette 200 in a second orientation, e.g., 180 degrees from the first orientation, such that strap 106 forms the opening on the left side of pipette 200 to thereby accommodate a left-handed user. As shown in FIG. 1B, a middle portion of strap 106, e.g., between first end 107 and free end 109, may have a larger width than first end 107 and/or free end 109 to thereby provide additional support against the backside of the user's hand, e.g., along or adjacent to the user's knuckles, during operation of pipette 200.

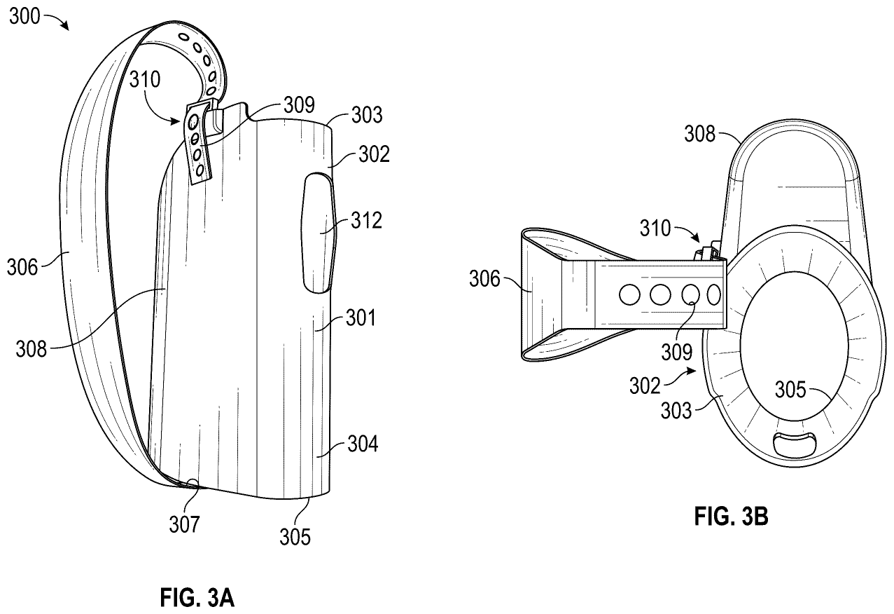

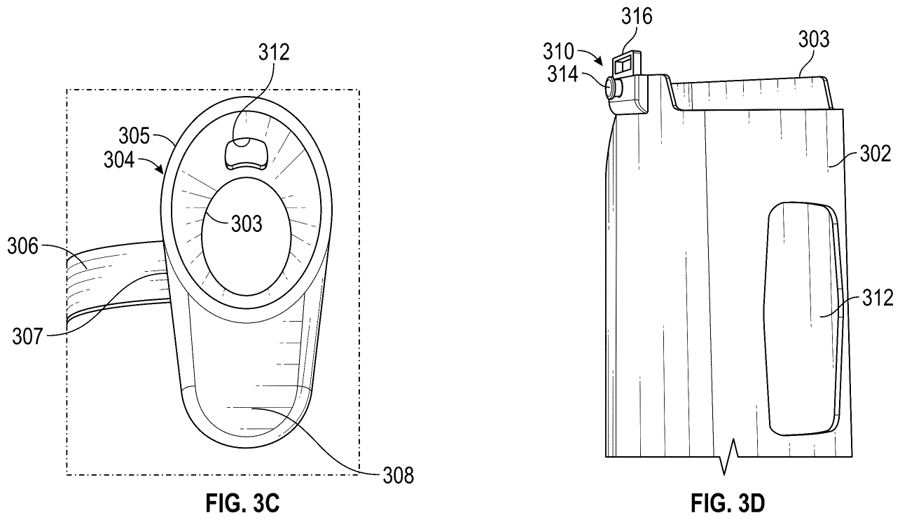

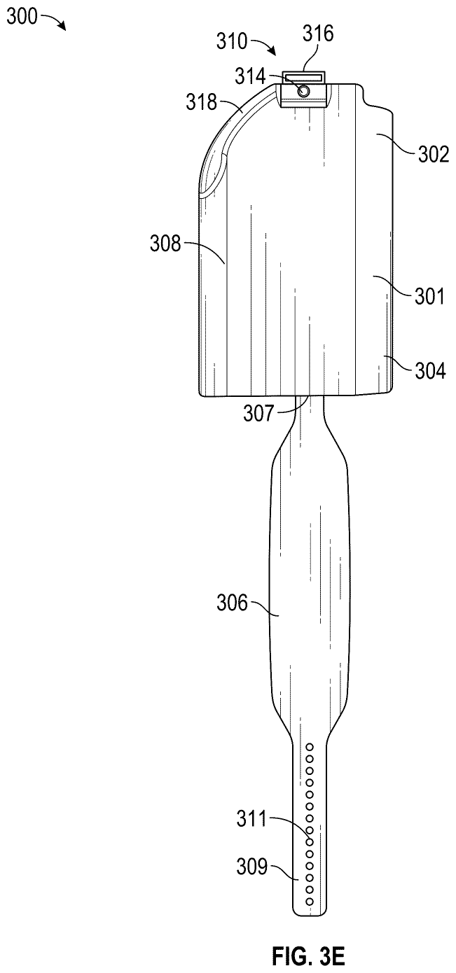

Referring now to FIGS. 3A to 3E, another exemplary grip support is provided. As shown in FIG. 3A, main body 301 of grip support 300 may include upper portion 302 defining inlet 303 at the upper end of grip support 300, lower portion 304 defining outlet 305 at the lower end of grip support 300, and a lumen extending between inlet 303 and outlet 305. As a variant of grip support 100, the outer surface of grip support 300 may extend continuously from inlet 303 to outlet 305 to form a tangible lumen. Accordingly, the lumen of grip support 300 for receiving at least a portion of the pipette, e.g., pipette 200, therethrough may extend continuously between inlet 303 and outlet 305, as shown in FIGS. 3B and 3C. Moreover, inlet 302, outlet 304, and the lumen of grip support 300 may be sized and shaped such that, when bottom end 206 of pipette 200 is inserted through inlet 303 and out of outlet 305 to removably coupled grip support 300 to pipette 200, bottom end 206 extends distally beyond outlet 305 and top end 202 of pipette 200 extends proximally from inlet 303, such that middle portion 204 of pipette 200 is supported within the lumen of grip support 300, as shown in FIGS. 4A and 4B. As shown in FIG. 4C, upper portion 302 may be sized and shaped such that, when grip support 300 is retained on middle portion 204 of pipette 200, all of the actuators of pipette 200, plunger 210 and tip ejector button 214, and fingerhook 208 are exposed from inlet 303 and unobstructed by grip support 300, such that the user may operate pipette 200 in the same manner as when grip support 300 is not coupled to pipette 200, albeit with reduced strain on the user's wrist and forearm during operation of pipette 200.

Referring again to FIG. 3A, grip support 300 further includes strap 306 extending between upper portion 302 and lower portion 304, and defining an opening sized and shaped to receive the user's fingers therethrough. Main body 301 and strap 306 may be formed of a deformable material, and may have smooth external surfaces to thereby facilitate disinfection and cleaning of grip support 300. Strap 306 may be fixedly coupled to a first portion of grip support 300 at a first end, and adjustably coupled to a second portion of grip support 300 at a second end opposite the first end, such that the size of the opening defined by strap 306 may be selectively adjusted to thereby accommodate various user hand sizes. For example, first end 307 of strap 306 may be fixedly coupled to lower portion 304, as shown in FIGS. 3A and 3C, and free end 309 of strap 306 may be adjustably coupled to upper portion 3102 via connection mechanism 310, as shown in FIGS. 3A and 3B.

Like connection mechanism 110 of grip support 100, connection mechanism 310 may include a first mating surface disposed on upper portion 302 and a second mating surface disposed on free end 309 of strap 306, the first and second mating surfaces configured to be removeably coupled to each other. For example, as shown in FIG. 3D, the first mating surface of connection mechanism 310 may include one or more pegs, e.g., peg 314, disposed on upper portion 302, and as shown in FIG. 3E, the second mating surface of connection mechanism 310 may include a plurality of notches 311 disposed along free end 309 of strap 306, each notch sized and shaped to removably and securely receive peg 314 therethrough, e.g., via an interference fit. Notches 311 may be disposed laterally along a length of free end 309, such that the user may selectively engage peg 314 with any one of notches 311 to thereby select the length of strap 306 defining the opening, and thus customize the size of the opening to accommodate a given user hand size.

Moreover, connection mechanism 310 further may include buckle 316 disposed adjacent to peg 314, and defining an opening sized and shaped to receive free end 309 therethrough, e.g., prior to coupling peg 314 to notch 311, to thereby facilitate securement of free end 309 to upper portion 302. For example, free end 309 may be inserted through buckle 316, e.g., from a radially inward side of buckle 316 towards a radially outward side of buckle 316, in a downward direction towards peg 314. Accordingly, free end 309 may be completely separated from upper loop 302 in an open configuration, as shown in FIG. 3E, and adjustably coupled to upper portion 302 via connection mechanism 310 in a closed configuration, as shown in FIG. 3A. Alternatively, free end 309 may remain engaged with, though adjustable relative to, upper portion 302, e.g., via a stop that prevents free end 309 from being completely removed through buckle 316. As shown in FIG. 3E, a middle portion of strap 306, e.g., between first end 307 and free end 309, may have a larger width than first end 307 and/or free end 309 to thereby provide additional support against the backside of the user's hand, e.g., along or adjacent to the user's knuckles, during operation of pipette 200.

While FIG. 3A illustrates first end 307 fixedly coupled to lower portion 304 and free end 309 adjustably coupled to upper portion 302, as will be understood by a person having ordinary skill in the art, first end 307 may be fixedly coupled to upper portion 302 and free end 309 may be adjustably coupled to lower portion 304, such that connection mechanism 310 is disposed at lower portion 304. Alternatively, strap 306 may be adjustably coupled to both upper portion 302 and lower portion 304 of grip support 300, e.g., via respective connection mechanisms. Moreover, as described above, instead of an adjustable peg/notch fastener system, connection mechanism 310 may include other types of adjustable fastener systems including, for example, reclosable fasteners, e.g., hook and loop fasteners, snaps, magnets, clips etc. For example, the first mating surface of connection mechanism 310 may include a plurality of hook and/or loop fasteners, and the second mating surface of connection mechanism 310 may include a plurality of loop and/or hook fasteners configured to releasably engage with the first mating surface.

As shown in FIG. 3D, main body 301 further may include window 312 extending from the outer surface of main body 301 to the lumen of grip support 300, to thereby expose at least a portion of the lumen. Window 312 may be disposed on a lateral front side of main body 301 such that, when grip support 300 is removably coupled to pipette 200, window 312 is aligned with indicator 218 of pipette 200 and indicator 218 is visible through window 312, as shown in FIG. 4D. While FIGS. 3A to 4D illustrate grip support 300 having strap 306 adjustably coupled a right side of main body 301 to thereby accommodate a right-handed user, as will be understood by a person having ordinary skill in the art, first end 307 of strap 306 may be coupled to a left side of main body 301 and free end 309 may be adjustably coupled to a left side of main body 301, e.g., via connection mechanism 310 to thereby accommodate a left-handed user.

Referring again to FIG. 3E, grip support 300 further may include extended portion 308 protruding in a rearward direction from a rear side of main body 301, e.g., opposite to window 312, and sized and shaped to provide additional support to the user's hand to facilitate gripping of pipette 200/main body 301 during operation of pipette 200. For example, extended portion 308 may increase a gripped dimension of the pipette by at least 10%. As shown in FIG. 3E, extended portion 308 may extend along the entire length of main body 301, e.g., from upper portion 302 to lower portion 304. In addition, upper portion 318 of extended portion 308 may have a curved geometry configured to support the thenar region of the user's hand during operation of pipette 200. Extended portion 308 may be formed of a deformable material and may have a smooth external surface to thereby facilitate disinfection and cleaning of grip support 300. Extended portion 308 may be formed integrally with main body 301.

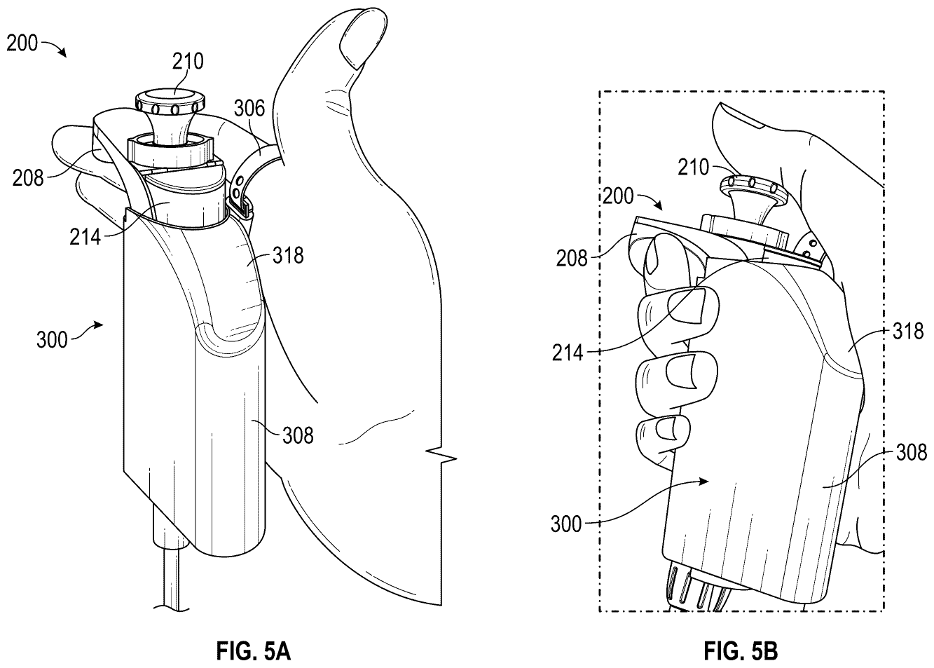

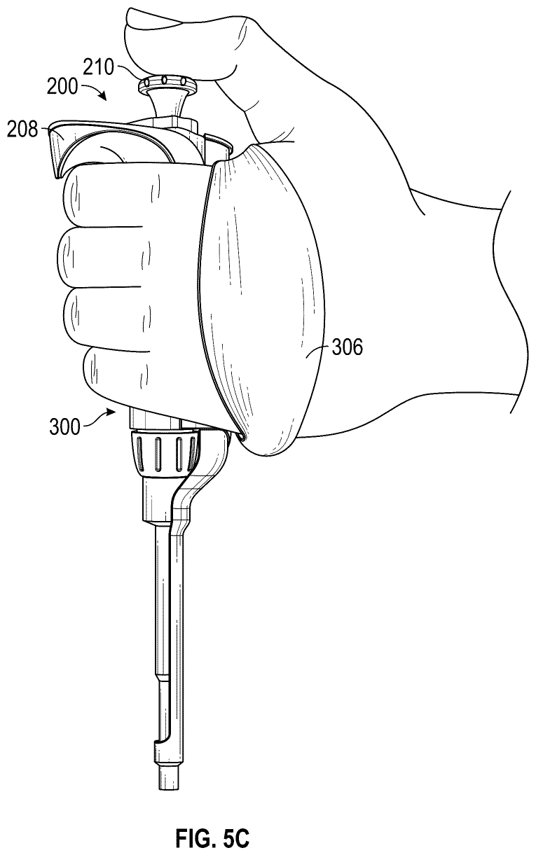

Referring now to FIGS. 5A to 5C, operation of pipette 200 removably coupled to an exemplary grip support 300 is provided. During operation of pipette 200 removably coupled to grip support 300, the user's fingers are inserted through the opening defined by strap 306, as shown in FIG. 5A, such that pipette 200 may be completely supported on the user's hand via strap 306, which sits on the backside of the user's hand, as shown in FIG. 5C, and the user's thumb is free to actuate the actuators of pipette 200, e.g., plunger 210 and/or tip ejector button 214. As pipette 200 is completely supported on the user's hand via strap 306, the user's fingers need not exert force to grip pipette 200/main body 301 to permit actuation of pipette 200 via the user's thumb. As shown in FIG. 5B, the user's fingers may wrap around the front side of main body 301, such that fingerhook 208 is supported on the user's finger, e.g., the user's index finger, to thereby provide additional support against pipette 200/main body 301 during operation of pipette 200. Moreover, as shown in FIG. 5B, upper portion 318 of extended portion 308 may contact and support the thenar region of the user's hand to thereby facilitate gripping and/or stabilizing the pipette 200/main body 301 by the user with less tension or force required from, for example, the user's thumb and wrist. During operation of pipette 200 removably coupled to grip support 300, the user may unwrap one or more fingers from main body 301 to expose window 312, and accordingly indicator 218 of pipette 200, so that the user may readily visually observe the amount of liquid within pipette 200.

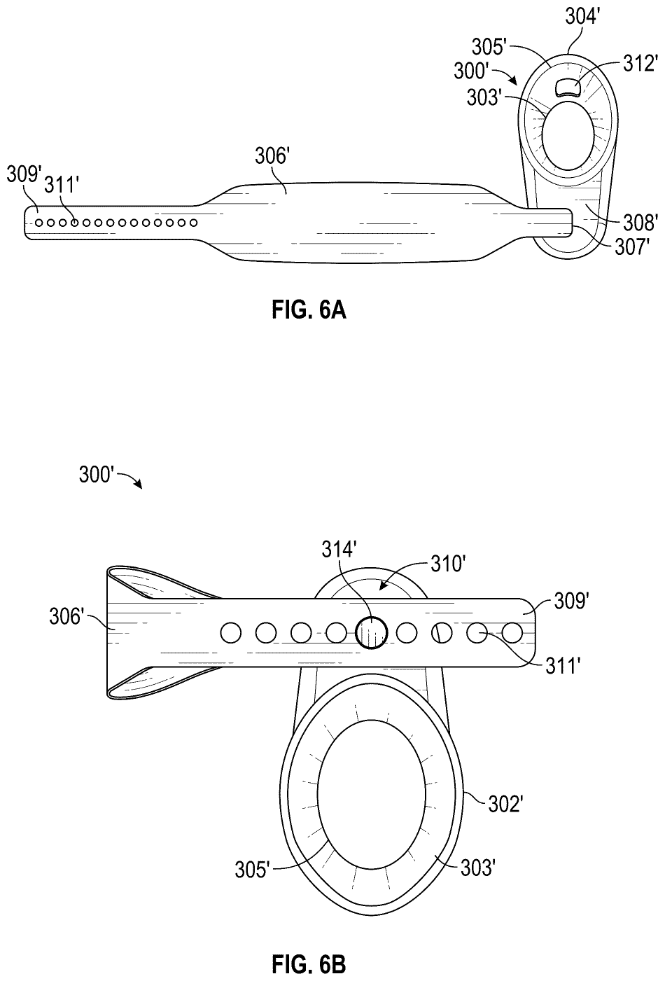

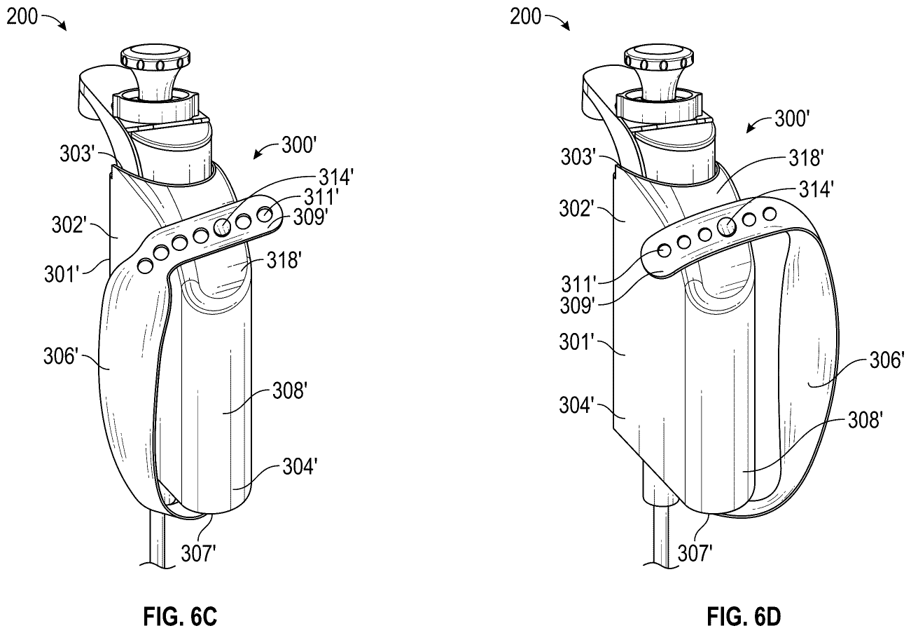

Referring now to FIGS. 6A to 6D, an exemplary universal grip support for use with a manually operated handheld pipette, e.g., pipette 200, is provided. Universal grip support 300′ may be constructed similar to grip support 300, with similar components having like-prime reference numerals. For example, main body 301′ having upper portion 302′ defining inlet 303′, lower portion 304′ defining outlet 305′, a lumen extending between inlet 303′ and outlet 305′, window 312′, and extended portion 308′, and adjustable strap 306′ having first end 307′ coupled to a first portion of main body 301′, e.g., lower portion 304′, and free end 309′ configured to be adjustably coupled to second portion of main body 301′, e.g., upper portion 302′, via connection mechanism 310′, and extended portion 308′ correspond with main body 301 and adjustable strap 306 of grip support 300. Universal grip support 300′ differs from grip support 300 in that strap 306′ is configured to be adjustably coupled to main body 301′ in a first orientation relative to main body 301′ where strap 306′ defines an opening on a left side of main body 301′ to thereby accommodate a left-handed user, as shown in FIG. 6C, and in a second orientation relative to main body 301′ where strap 306′ defines an opening on a left side of main body 301′ to thereby accommodate a left-handed user, as shown in FIG. 6D.

For example, as shown in FIG. 6A, first end 307′ of strap 306′ may be coupled to a central region on the bottom surface of universal grip support 300′, e.g., the bottom surface of extended portion 308′, such that strap 306′ may be folded towards either right or left side of main body 301′. Moreover, the first mating surface of connection mechanism 310′ may be disposed on a central region on the upper surface of universal grip support 300′, e.g., on upper surface 318′ of extended portion 308′, such that the second mating surface of connection mechanism 310′, e.g., plurality of notches 311′ on free end 309′ of strap 306′, may be coupled to the first mating surface in the first orientation to define the opening on the left side of main body 301′ to thereby accommodate a left-handed user, or in the second orientation to define the opening on the right side of main body 301′ to thereby accommodate a right-handed user, as shown in FIG. 6B. As shown in FIG. 6B, connection mechanism 310′ need not include a buckle for receiving free end 309′ therethrough to facilitate securement of free end 309′ to upper portion 302′, e.g., via peg 314′ and plurality of notches 311′, due to the orientation of peg 314′ and notch 311′ relative to strap 306′ when free end 309′ is adjustably coupled to upper portion 302′. For example, when peg 314′ is disposed on an upper surface of universal grip support 300′, the force applied to peg 314′ by free end 309′ is in a direction substantially perpendicular to the longitudinal axis of peg 314′. In addition, the middle region of strap 306′ may be wider than the middle region of strap 306, to thereby provide additional support to the user's hand during operation of pipette 200 removably coupled to grip support 300′.

As described above, while FIGS. 6A to 6D illustrates first end 307′ fixedly coupled to a central region of lower portion 304′ and free end 309′ adjustably coupled to a central region of upper portion 302′, as will be understood by a person having ordinary skill in the art, first end 307′ may be fixedly coupled to a central region of upper portion 302′, e.g., upper portion 318′ of extended portion 308′, and free end 309′ may be adjustably coupled to a central region of lower portion 304′, such that connection mechanism 310′ is disposed at the central region of lower portion 304′. Alternatively, strap 306′ may be adjustably coupled to both upper portion 302′ and lower portion 304′ of grip support 300′, e.g., via respective connection mechanisms. Moreover, as described above, instead of an adjustable peg/notch fastener system, connection mechanism 310′ may include other types of adjustable fastener systems including, for example, reclosable fasteners, e.g., hook and loop fasteners.

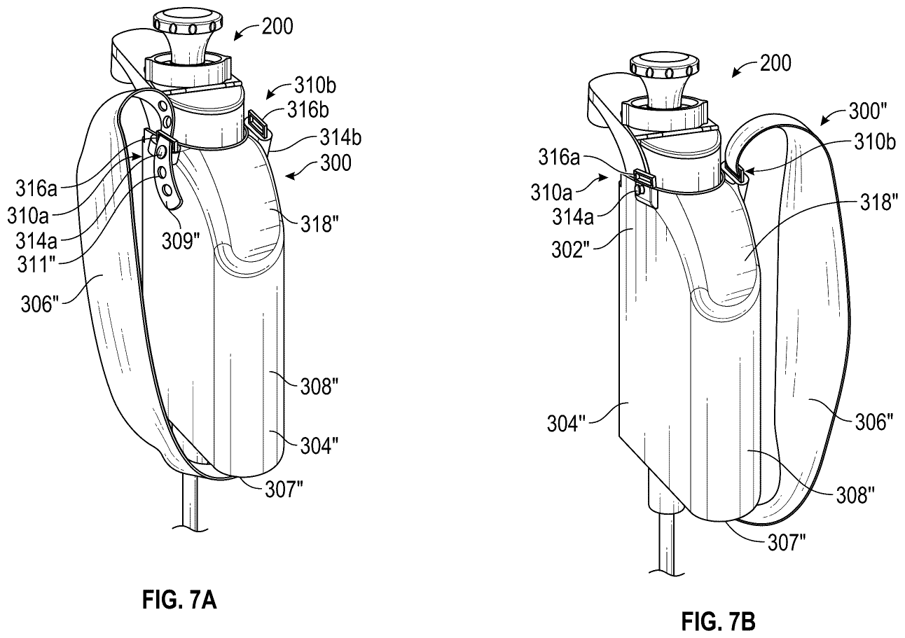

Referring now to FIGS. 7A and 7B, another exemplary universal grip support for use with a manually operated handheld pipette, e.g., pipette 200, is provided. Universal grip support 300″ may be constructed similar to universal grip support 300′, with similar components having like-double prime reference numerals. For example, main body 301″ having upper portion 302″ defining inlet 303″, lower portion 304″ defining outlet 305″, a lumen extending between inlet 303″ and outlet 305″, window 312″, and extended portion 308″, and adjustable strap 306″ having first end 307″ coupled to a central region of a first portion of main body 301″, e.g., lower portion 304″, and free end 309″ configured to be adjustably coupled to a central region of a second portion of main body 301″, e.g., upper portion 318″ of extended portion 308″ at upper portion 302″, and extended portion 308″ correspond with main body 301′ and adjustable strap 306′ of universal grip support 300′.

Universal grip support 300″ differs from universal grip support 300′ in that strap 306″ is configured to be adjustably coupled to main body 301″ on a left side of main body 301″ via connection mechanism 310a to define an opening on a left side of main body 301″ to thereby accommodate a left-handed user, as shown in FIG. 7A, and on a right side of main body 301″ via connection mechanism 310b to define an opening on a right side of main body 301″ to thereby accommodate a right-handed user, as shown in FIG. 7B. For example, as shown in FIGS. 7A and 7B, main body 301″ may include the first mating surface of the connection mechanism, e.g., one or more pegs, on both a right side of upper portion 302″, e.g., peg 314a of connection mechanism 310a, and a left side of upper portion 302″, e.g., peg 314b of connection mechanism 310b, such that the second mating surface of the connection mechanism, e.g., plurality of notches 311″ on free end 309″ of strap 306″, may be coupled to peg 314a to define the opening on the left side of main body 301″ to thereby accommodate a left-handed user, as shown in FIG. 7A, or to peg 314b to define the opening on the right side of main body 301″ to thereby accommodate a right-handed user, as shown in FIG. 7B. Moreover, as shown in FIGS. 7A and 7B, like connection mechanism 110, connection mechanisms 310a, 310b of universal grip support 300″ further may include buckle 316a adjacent to peg 314a and buckle 316b adjacent to peg 314b, respectively, each defining an opening sized and shaped to receive free end 309″ therethrough to facilitate securement of free end 309″ to peg 314a and 314b.

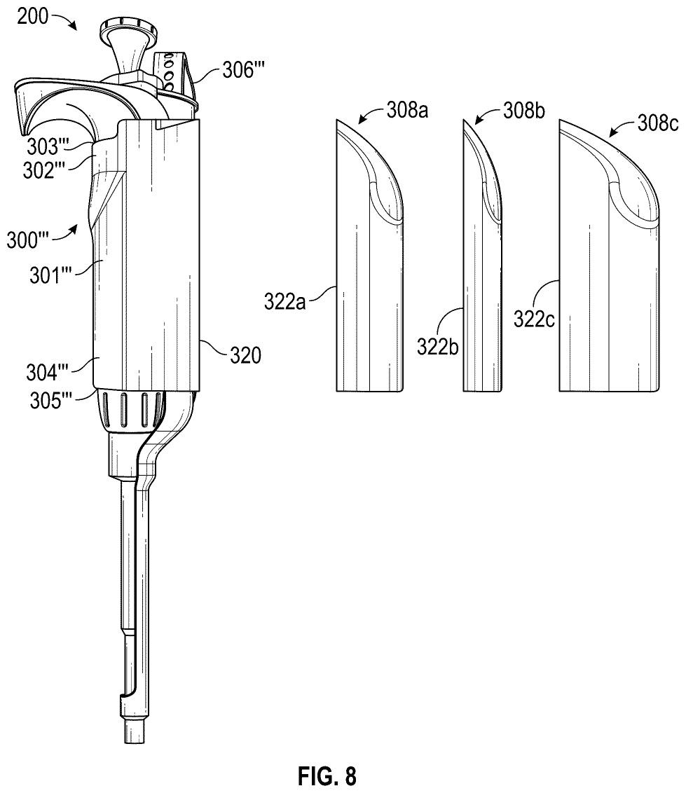

Referring now to FIG. 8, another exemplary grip support for use with a manually operated handheld pipette, e.g., pipette 200, is provided. Grip support 300′″ may be constructed similar to any one of grip supports 300, 300′, 300″ described above, with similar components having like-triple prime reference numerals. For example, main body 301′″ having upper portion 302′″ defining inlet 303′″, lower portion 304′″ defining outlet 305′″, and a lumen extending between inlet 303′″ and outlet 305′″, and adjustable strap 306′″ corresponds to main bodies 301, 301′, 301″ and adjustable straps 306, 306′, 306″. Grip support 300″ differs from grip supports 300, 300′, 300″ in that grip support 300′″ includes a removable and interchangeable extended portion, e.g., interchangeable extended portions 308a, 308b, 308c. Each of interchangeable extended portions 308a, 308b, 308c may have a unique width selected to support a specific user hand size or a specific range of average user hand sizes. For example, as shown in FIG. 8, interchangeable extended portion 308b may have a smaller width than interchangeable extended portion 308a, and interchangeable extended portion 308a may have a smaller width than interchangeable extended portion 308c.

Accordingly, the user may select the desired interchangeable extended portion to be removably coupled to the rear portion of main body 301′″, e.g., via first connection surface 320 disposed on the rear portion of main body 301′″ and second connection 322a, 322b, 322c disposed on a front portion of interchangeable extended portions 308a, 308b, 308c, respectively, based on the user's hand size. Accordingly, second connection 322a, 322b, 322c may be configured to be removably coupled to first connection surface 320, e.g., via an adhesive, interference fit, reclosable fasteners, snaps, magnets, clips, etc. As will be understood by a person having ordinary skill in the art, the extended portions of any of the grip support devices described herein may be removable and interchangeable, as described above with regard to FIG. 8. In some embodiments, the extended portion forms an integrated portion of the grip support that is not removable, and grip supports with integrated extended portions of different sizes are provided in a kit, such that a user may select a grip support of an appropriate size. In some embodiments, an extended portion (whether removable or not) is sized to increase a width of a pipette to which it is attached by at least 10%, 20%, 30%, 40%, 50%, 75%, 100%, or more. In some embodiments, the extended portion is sized to increase a width of a pipette to which it is attached by at least 50%. In some embodiments, the extended portion is sized to increase a width of a pipette to which it is attached by at least 100%.

A variety of materials are suitable for the construction of grip supports of the various embodiments herein. Non-limiting examples of which include plastic. In some embodiments, the material is medical grade thermoplastic that can withstand high-level disinfection by a quaternary ammonium sterilant or high heat autoclaving. In some embodiments, the material is polypropylene or polyethylene.

A variety of construction processes are suitable for the manufacturing of grip supports of the various embodiments. Non-limiting examples include injection molding, 3D printing, etc. In some embodiments, different elements of a grip support are constructed separately for assembly, for example, through processes including but not limited to thermal welding. In some embodiments, a grip support is constructed as a single unity piece.

While various illustrative embodiments of the invention are described above, it will be apparent to one skilled in the art that various changes and modifications may be made therein without departing from the invention. The appended claims are intended to cover all such changes and modifications that fall within the true scope of the invention.

What is claimed:

1. A device for supporting manual operation of a pipette, the device comprising:
a main body comprising an upper portion defining an inlet, a lower portion defining an outlet, and a lumen extending between the inlet and the outlet, the lumen sized and shaped to receive at least a portion of the pipette therethrough such that a distal portion of the pipette extends distally beyond the outlet and a proximal portion of the pipette extends proximally from the inlet; and
a strap configured to extend between the upper and lower portions of the main body to define an opening sized and shaped to receive a user's fingers therethrough, the strap configured to be selectively adjusted to modify the size of the opening,
wherein, when the at least the portion of the pipette is received within the lumen and the user's fingers are received through the opening, the strap supports the pipette on the user's hand to permit actuation of the pipette.

2. The device of claim 1, wherein a first end of the strap is coupled to the lower portion or the upper portion, and wherein a second end of the strap is configured to be adjustably coupled to the other one of the lower portion or the upper portion.

3. The device of claim 2, wherein the other one of the lower portion or the upper portion comprises a first mating surface, and wherein the second end of the strap comprises a second mating surface configured to be removably coupled to the first mating surface.

4. The device of claim 3, wherein the first mating surface comprises a peg, and wherein the second mating surface comprises a plurality of notches, each of the plurality of notches sized and shaped to securely receive the peg therethrough via an interference fit.

5. The device of claim 3, further comprising a buckle disposed adjacent to the first mating surface, the buckle defining an opening sized and shaped to receive the second end of the strap therethrough to facilitate securement of the second mating surface to the first mating surface.

6. The device of claim 3, wherein the first and second mating surfaces comprise reclosable fasteners.

7. The device of claim 3, wherein the first end of the strap is coupled to a central region of a lower surface of the lower portion or to a central region of an upper surface of the upper portion.

8. The device of claim 7, wherein the first mating surface is disposed on a central region of a lower surface of the lower portion or on a central region of an upper surface of the upper portion, and wherein the second mating surface is configured to be removably coupled to the first mating surface at a first orientation to accommodate a right-handed user and removably coupled to the first mating surface at a second orientation to accommodate a left-handed user.

9. The device of claim 7, wherein both right and left lateral sides of the other one of the lower portion or the upper portion comprise the first mating surface, and wherein the second mating surface is configured to be removably coupled to the first mating surface on the right lateral side to accommodate a right-handed user and removably coupled to the first mating surface on the left lateral side to accommodate a left-handed user.

10. The device of claim 2, wherein the first end of the strap is fixedly coupled to the lower portion or the upper portion.

11. The device of claim 2, wherein a middle region of the strap comprises a width that is larger than a width of the first and/or second ends of the strap.

12. The device of claim 1, wherein the main body comprises a deformable material.

13. The device of claim 1, wherein the main body comprises a smooth outer surface configured to facilitate disinfection.

14. The device of claim 1, wherein a rear portion of the main body comprises an extended portion sized and shaped to facilitate gripping of the pipette and the main body by the user when the at least the portion of the pipette is received within the lumen and the user's fingers are received through the opening, wherein the extended portion increases a gripped dimension of the pipette by at least 10%.

15. The device of claim 14, wherein an upper portion of the extended portion comprises a curved surface configured to support a thenar region of the user's hand.

16. The device of claim 14, wherein the extended portion is removably coupled to the rear portion of the main body.

17. The device of claim 16, wherein the extended portion is selected from a plurality of interchangeable extended portions, each of the interchangeable extended portions sized and shaped to accommodate a predetermined user hand size.

18. The device of claim 1, wherein an outer surface of the main body extends continuously between the upper and lower portions of the main body.

19. The device of claim 18, wherein the main body comprises a window extending from the lumen to an outer surface of the main body, the window configured to be aligned with an indicator of the pipette when the at least the portion of the pipette is received within the lumen.

20. The device of claim 1, wherein the upper portion is only coupled to the lower portion via the strap.

21. The device of claim 20, wherein the upper portion comprises an upper loop configured to be removeably coupled to the proximal portion of the pipette, and wherein the lower portion comprises a lower loop configured to be removably coupled to the distal portion of the pipette.

22. The device of claim 1, wherein the inlet is sized and shaped to expose one or more actuators on the proximal portion of the pipette in an unobstructed manner when the at least the portion of the pipette is received within the lumen.

23. The device of claim 1, wherein, when the at least the portion of the pipette is received within the lumen and the user's fingers are received through the opening, the strap extends along or adjacent the user's knuckle to support the pipette on the user's hand.

24. A pipette comprising the device of claim 1 attached thereto, wherein the device and the pipette are separable.

25. A method of reducing risks of repetitive strain injury associated with manually operating a pipette, the method comprising attaching the device of claim 1 to the pipette.

26. A device for supporting manual operation of a pipette having a top end, a middle portion, and a bottom end, the top end being wider than and proximal to the middle portion, and the middle portion being wider than and proximal to the bottom end, the device comprising:
an upper loop sized and shaped to receive the bottom end and the middle portion of the pipette therethrough, and to be retained at the top end of the pipette;
a lower loop sized and shaped to receive the bottom end of the pipette therethrough, and to be retained by the middle portion of the pipette; and
a strap connecting the upper loop and the lower loop,
wherein the strap, when attached to the pipette via the upper and lower loops, defines an opening sized and shaped to (i) receive a user's fingers therethrough, (ii) support the pipette on the user's hand, and (iii) permit actuation of the pipette when held.

27. A pipette comprising the device of claim 26 attached thereto, wherein the device and the pipette are separable, and wherein the strap forms the opening.
